(19) United States
(12) Patent Application Publication
(10) Pub. No.: US 2010/0205367 A1
(43) Pub. Date: Aug. 12, 2010

(54) Method And System For Maintaining Cache Data Integrity With Flush-Cache Commands

(76) Inventors: Richard M. Ehrlich, Saratoga, CA (US); Andre Hall, Fremont, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/368,112

(22) Filed: Feb. 9, 2009

(51) Int. Cl. G06F 12/08

(52) U.S. Cl. 711/113; 711/135; 711/E12.001; 711/E12.022; 711/E12.019

(57) ABSTRACT

A non-volatile memory location in a disk drive is utilized to store data residing in a write-cache upon receiving a flush-cache command from a host computer. If a subsequent flush-cache command is not issued within a predetermined time period, any data residing in the write-cache and stored in the non-volatile memory location that has not yet been written to its correct location on disk will be written to its correct location on disk.

### BACKGROUND OF THE INVENTION

1. Field of the Invention

The present invention relates generally to disk drives, and more particularly, to improving caching techniques used in disk drives.

2. Description of the Related Art

Typical interactions between a host computer and a disk drive involve the host computer issuing read and write commands to the disk drive in order to access current data stored on the disk drive or store new data generated during computation by the host computer. Write commands that are received by a disk drive from the host computer contain specific information including the location on the disk where data is to be written.

Streams of read and write commands transmitted by a host computer to a disk drive can result in inefficiencies due to the mechanical limitations of disk drives if such commands are executed and completed in the order they are received by the disk drive. For example, switching between read and write operations can be time consuming and inefficient. Additionally, sequentially received write commands may require writing to different disk sectors that are physically distant from one another on the disk. Executing such write commands in the order they are received can thus result in significant inefficiencies.

Typical disk drives contain and utilize a “write-cache” to address the foregoing inefficiencies and enable the disk drive to immediately inform the host computer that a write command issued by the host computer has completed. The write-cache is a volatile memory component in the disk drive such as DRAM. When a write command is received from a host computer, the disk drive stores the data in the write-cache, instead of the appropriate locations on the disk, and informs the host computer that the write command has completed. The data in the write-cache is written to the disk sectors at a more efficient and appropriate time as determined by the disk drive.

However, such write-cache techniques may generate data integrity problems. For example, a loss of power before the disk drive is able to write data from the write-cache to its appropriate disk sector results in a loss of all data in the write-cache because the write-cache is a volatile memory (despite the disk drive having informed the host computer that the write command was successful). As such, disk drives also support a “flush-cache” command. A disk drive receiving a flush-cache command from a host computer writes all the data in the write-cache to their designated disk sectors before informing the host computer that the command has been completed. Because executing flush-cache commands can also be time consuming, techniques have been developed to more efficiently execute these commands. One such technique is described in co-pending U.S. Patent Application Publication 2007/0226411, entitled “Disk Drive Write Method,” which is hereby incorporated by reference (referred to herein as the “Ehrlich-Zayas Publication”). As further described therein, a special non-volatile memory location in the disk drive, referred to as a flush-cache location, may be used in response to a flush-cache command. Rather than immediately writing the data in the write-cache to its correct locations on disk, data in the write-cache is written to the flush-cache location, from which data can be recovered in the event of loss of power. This enables the disk drive to quickly inform the host computer that the flush-cache command has been completed and simultaneously provides the disk drive some additional time (in the future when writing the data to the correct locations on disk is more efficient and timely) to write the data to disk without concern that loss of power will cause loss of data. In the event that loss of power occurs, during recovery, the data in the flush-cache location is restored into the write-cache and the disk drive can continue committing the data from the write-cache to its correct location in memory.

Nevertheless, because the host computer has discretion in issuing flush-cache commands to the disk drive, data integrity issues may still arise in certain situations. For example, a host computer may issue a flush-cache command (thereby causing the data in the write-cache to be saved to the flush-cache location) and then not issue another flush-cache command for some time. In the meanwhile, the host may continue to issue write commands to the disk drive, including writing data to the same disk locations several times over. In such a scenario, if loss of power occurs, during recovery, the disk drive will attempt to restore stale data from the flush-cache location.

### SUMMARY OF THE INVENTION

One or more embodiments of the invention provide techniques to maintain data integrity between a write-cache and flush-cache location of a disk drive in order to prevent stale data in the flush-cache location from being restored into the write-cache upon power loss.

A method for managing a write-cache of a disk drive according to an embodiment of the invention includes the steps of writing data stored in the write-cache onto a flush cache location on disk upon receiving a flush cache command, setting a dirty flag corresponding to the flush cache location, writing data stored in the write-cache onto locations on disk corresponding to the data when a predetermined amount of time has elapsed since execution of the flush cache command, and clearing the dirty flag corresponding to the flush cache location.

A disk drive according to an embodiment of the invention includes a disk, a volatile memory write-cache, a non-volatile memory flush-cache location, and a controller that is configured to: (a) write data stored in the write-cache into the flush-cache location upon receiving a flush cache command and set a dirty flag corresponding to the flush-cache, and (b) write data stored in the write-cache onto locations on the disk when a predetermined amount of time has elapsed since execution of the flush cache command and clear the dirty flag.

The present invention also provides a computer readable storage medium that has stored therein computer readable instruction for execution by a controller of a disk drive having a disk and a write-cache. The controller executing the instructions carries out the steps of writing data stored in the write-cache onto a flush cache location on disk upon receiving a flush cache command, setting a dirty flag corresponding to the flush cache location, writing data stored in the write-cache onto locations on disk corresponding to the data when a predetermined amount of time has elapsed since execution of the flush cache command, and clearing the dirty flag corresponding to the flush cache location.

### BRIEF DESCRIPTION OF THE DRAWINGS

FIG. 1 depicts a write-cache data structure.

FIG. 2 depicts a flush-cache location on a disk.

FIG. 3A is a block diagram illustrating a disk drive.

FIG. 3B is a block diagram illustrating components of printed circuit board of a disk drive.

FIG. 3C is a block diagram illustrating components of a system-on-chip of a printed circuit board of a disk drive.

FIG. 4 is a flow chart depicting steps taken within a disk drive upon receiving commands from a host computer in accordance with one embodiment of the present invention.

FIG. 5 is a flow chart depicting steps taken within a disk drive upon an expiration of a flush cache timer in accordance with an embodiment of the present invention.

### DETAILED DESCRIPTION

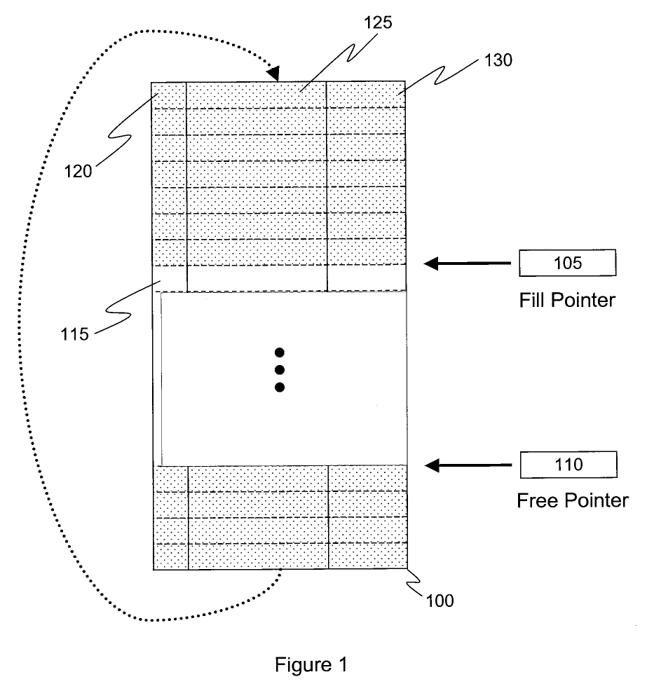

FIG. 1 depicts a write-cache data structure. Write-cache 100 is a volatile memory component, such as DRAM, within a disk drive and is structured as a circular buffer with a fill pointer 105 and free pointer 110. Fill pointer 105 points to the next entry in write-cache 100 that can receive data from a write command and free pointer 110 points to the end of the portion of the circular buffer containing free write-cache entries. When a host computer issues a write command to a disk drive, the disk writes the data and any relevant metadata information (e.g., disk location, etc.) starting with an entry 115 of write-cache 100 pointed to by fill pointer 105. Each entry in write-cache 100 includes a dirty flag 120 (e.g., a bit), data 125 to be written, and a location 130 on disk where data 125 is to be written.

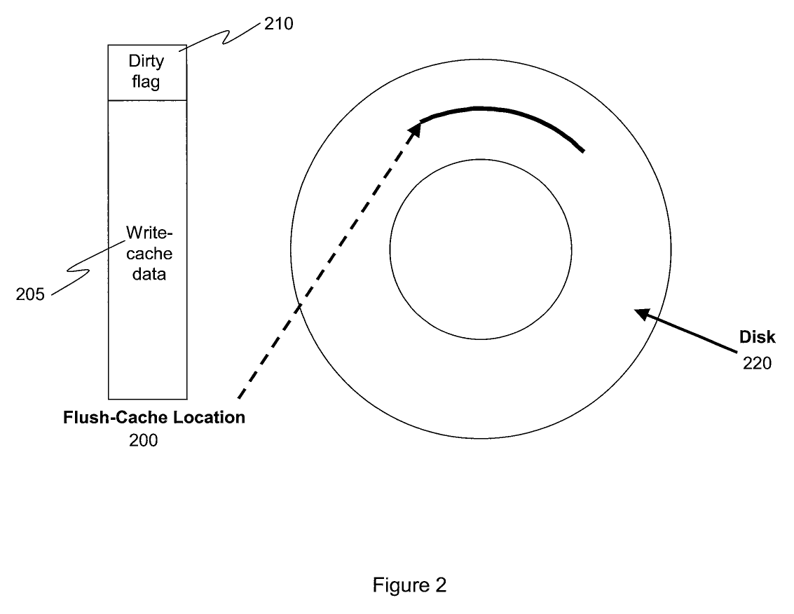

FIG. 2 depicts a flush-cache location 200 on a disk 220. Flush-cache location 200 contains a data component 205 for storing data and corresponding metadata information (e.g., disk location, etc.) relating to write-cache entries, and a dirty flag 210 (e.g., a bit) to indicate whether the contents in data component 205 have been written to their correct locations on disk. In FIG. 2, flush-cache location 200 is located on a specified track on disk 225. It should be recognized however, that flush-cache location 200 may be contained in any non-volatile memory component of a disk drive. For example, an alternative flush-cache location 200 may be a separate EEPROM within the disk drive or any other similar non-volatile memory component known to those of ordinary skill in the art. In alternative embodiments, flush-cache location 200 on disk may dynamically change, or multiple flush-cache locations (on disk or on other memory components in the disk drive) may be provided. Upon power-up of the drive, if dirty flag 210 is set, the disk drive will restore the contents of write-cache 100 with the data residing in data component 205 of flush-cache location 200.

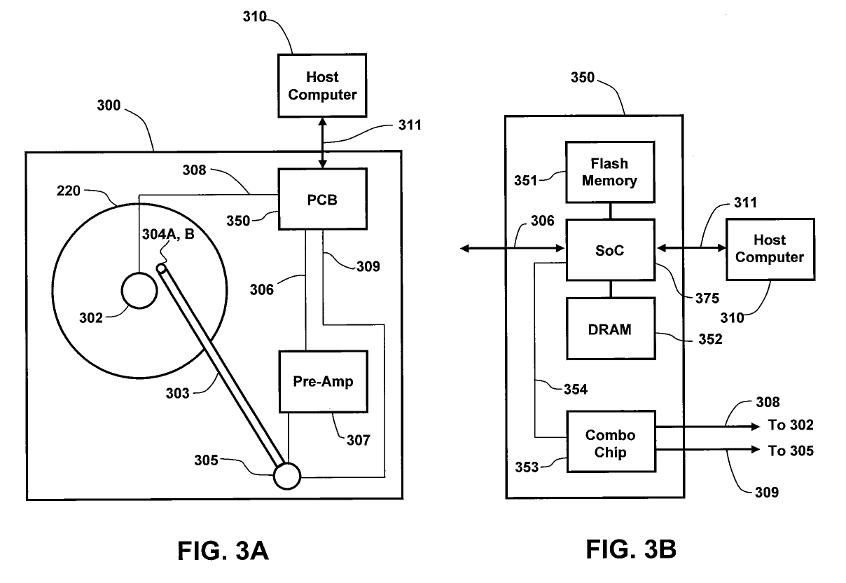

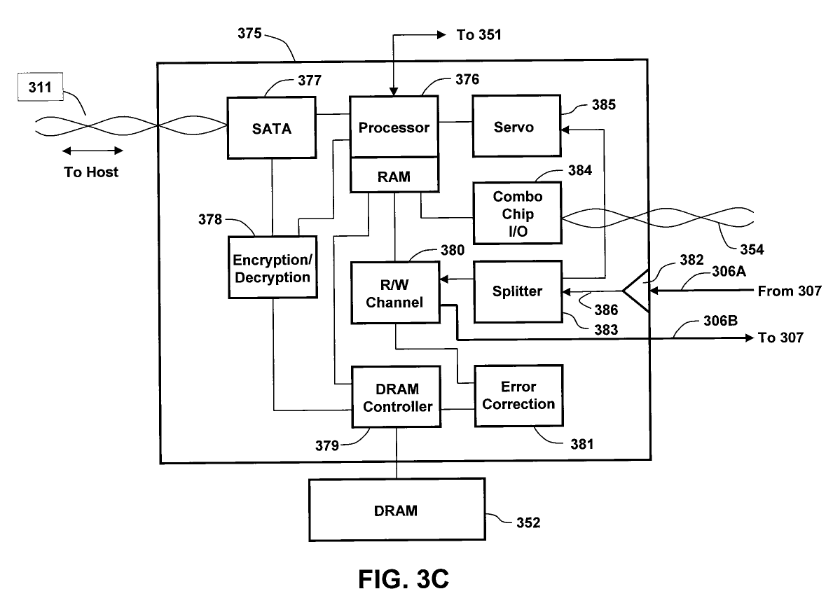

FIG. 3A is a block diagram illustrating a disk drive 300, that may be configured in accordance with techniques herein. The mechanical components of disk drive 300 include magnetic disk 220 rotated by a spindle motor 302, a read/write head 304 disposed on the end of a suspension arm 303. Arm actuator 305 is coupled to suspension arm 303 for moving arm 303 as desired to access different tracks of magnetic disk 220. Electronic components of disk drive 300 include a printed circuit board (PCB) 350, and a pre-amplifier 307, the latter of which is electrically coupled to read/write head 304. Pre-amplifier 307 conditions and amplifies signals to and from read/write head 304. PCB 350 includes a system-on-chip (SoC), RAM, and other integrated circuits for operating disk drive 300, and is described below in conjunction with FIGS. 3B and 3C. As shown, PCB 350 is electrically coupled to pre-amplifier 307 via electrical connection 306, to spindle motor 302 via electrical connection 308, and to arm actuator 305 via electrical connection 309. PCB 350 communicates with a host computer 310 via cable 311, which may be an SATA, PATA, SCSI, or other interface. Host computer 310 may be a laptop computer, a desktop computer, or an appliance such as set-top boxes, televisions and video players, requesting access to one or more sectors of an encryption-enabled storage device contained in the computer or a remote computing device accessing the storage device over a LAN or WAN.

FIG. 3B is a block diagram schematically illustrating components of PCB 350 from FIG. 3A. PCB 350 includes an SoC 375, DRAM 352, which may be internal or external to SoC 375, flash memory 351, and a combo chip 353, which drives spindle motor 302 and arm actuator 305. Combo chip 353 also includes voltage regulators for SoC 375, pre-amplifier 307, and the motor controllers contained in SoC 375. As shown, flash memory 351 and DRAM 352 are coupled to SoC 375, which interfaces with the host computer 310 via cable 311, pre-amplifier 307 via electrical connection 306, and combo chip 353 via serial bus 354. In some embodiments, flash memory 351 resides in SoC 375. Firmware for disk drive 300 resides in flash memory 351.

As depicted in FIG. 3C, DRAM controller 379 refreshes DRAM 352 and arbitrates the use of DRAM 352, making DRAM 352 accessible to encryption/decryption block 378, processor 376, read/write channel 380, and error correcting and generating block 381, as needed for the proper operation of disk drive 300. DRAM 352 serves as a DRAM buffer for data being written to or read from magnetic disk 220 and for data received from the host after encryption. DRAM 352 may be external to SoC 375 as shown, or, alternatively, may make up one of the functional blocks contained therein. It should be recognized that in certain embodiments, DRAM 352 or a portion of DRAM 352 may serve as write-cache 100. For error-free retrieval of data from magnetic disk 220, error correction block 381 applies error correction to data read from magnetic disk 220 before the data is buffered in DRAM 352 for decryption and transmission to the host. In addition, when data is being written to magnetic disk 220, error correction block 381 appends information to said data to allow error correction upon retrieval of the data from magnetic disk 220.

In order for the host to retrieve data from magnetic disk 220, data is read from magnetic disk 220 by read/write head 304, conditioned by pre-amplifier 307, and carried as an analog signal by electrical connection 306A to SoC 375. This analog signal is conditioned by an analog signal conditioning circuitry (not shown) and a phase-locked loop (not shown) before it is supplied to an analog-to-digital converter 382. Analog-to-digital converter 382 converts the analog signal to a digital signal 386, which is transmitted to a splitter block 383. A phase-locked loop is included so that analog-to-digital converter 382 samples the analog signal at proper intervals. From digital signal 386, splitter block 383 sends the appropriate servo-related data to servo block 385 for optimal control of spindle motor 302 and arm actuator 303 using motor 305. Splitter block 385 sends the data requested by the host to read/write channel 380, which routes the data through error correction block 381 to DRAM 352 for buffering until said data can be decrypted and transmitted to the host.

For storage of data on magnetic disk 220 by the host, data is buffered in DRAM 352 as necessary and routed through error correction block 381 and then to read/write channel 380. Read/write channel 380 then sends a digital signal via electrical connection 306B to pre-amplifier 307, which conditions and amplifies the digital signal for reads/write head 304 to write the encrypted data onto magnetic disk 220. One of skill in the art will appreciate that encrypted data resides in the storage media contained in disk drive 300, i.e., DRAM 352 and magnetic disk 220.

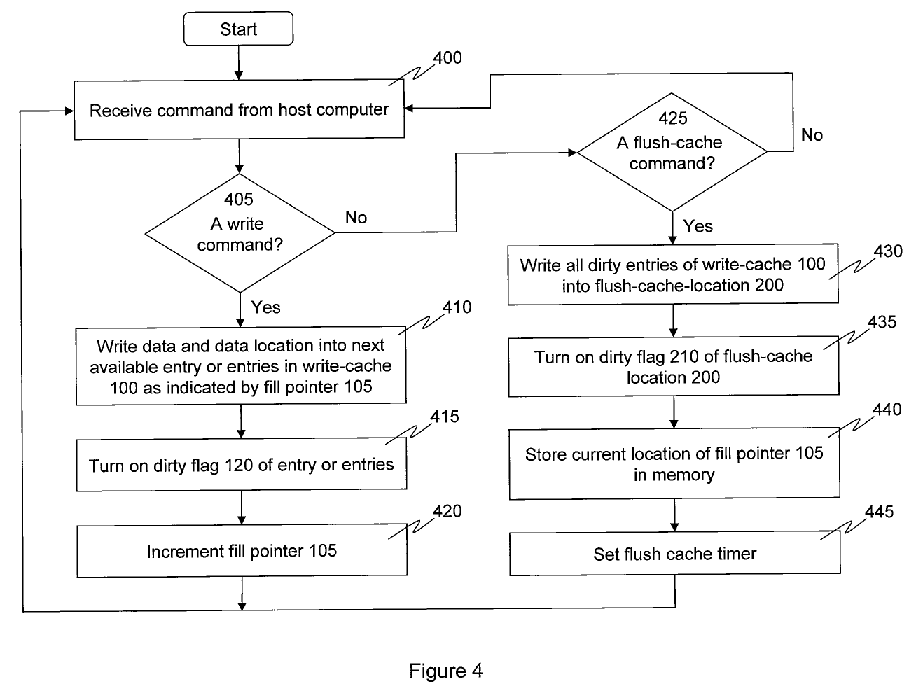

FIG. 4 is a flow chart depicting steps taken within a disk drive upon receiving commands from a host computer in accordance with one embodiment of the present invention. In step 400, the disk drive receives a command from the host computer. If, in step 405, the received command is a write command, the data and location on disk where the data is to be written are written into the entry (or entries) of write-cache 100 pointed to by fill pointer 105 in step 410. The dirty flag of the entry (or each of the entries) is set in step 415 and fill pointer 105 is incremented appropriately (consistent with number of entries used in step 410) in step 420.

If, instead, in step 425, the received command is a flush-cache command, all entries in the write cache that have their dirty flags set are written into data component 205 of flush-cache location 200 (step 430). In step 435, dirty flag 210 of flush-cache location 200 is set and in step 440, the current location pointed to by fill pointer 105 is stored in memory used by the disk drive, e.g., RAM illustrated in FIG. 3C. In step 445, a flush cache timer is turned on. This flush cache timer is set to expire at a predetermined and/or configurable time (e.g., 5 seconds, etc.) upon which the disk drive is notified to “clear” the flush-cache location 200 if it has not already done so, as further described below.

During normal operations, the drive may determine that it is timely to write certain data entries in write-cache 100 to their correct locations on disk, for example, because the disk head is currently near relevant tracks or sectors corresponding to such entries or read commands have been completed or there is generally idle time. The data in a chosen entry in write-cache 100 is written to its correct location on the disk and the dirty flag of the entry is cleared. If the cleared data entry is the entry pointed to by free pointer 110, then the free pointer 110 is incremented. If the location pointed to by free pointer 110 now equals the fill pointer location stored in fill pointer 215 of flush-cache location 200, then the dirty flag 210 of flush-cache location 200 is cleared, indicating that all data stored in flush-cache location 200 has been written to their correct locations on disk.

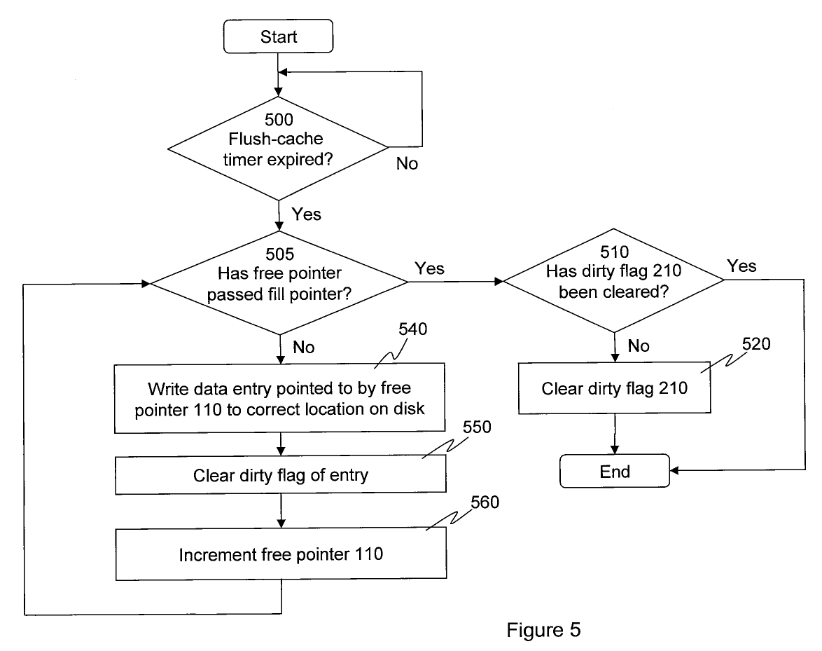

It may be the case, however, that during normal operations, the flush cache timer of step 445 expires before all the data stored in flush cache location 200 has been written to their correct locations on disk (i.e., flush cache location 200 is still dirty). In such an scenario, upon expiration of the flush cache timer, the disk drive gives priority to writing any remaining data in flush-cache location 200 that has not yet been written to its correct location on disk. FIG. 5 depicts steps taken within a disk drive upon an expiration of a flush cache timer in accordance with an embodiment of the present invention. If in step 500, the flush-cache timer set in step 445 expires, then in step 505, it is determined whether the free pointer 110 has passed the fill pointer location stored in memory. If so, in step 510, the dirty flag 210 of flush-cache location 200 is checked to see if it has been cleared. If so, all data in flush-cache location 200 have been written to their correct locations on disk and no further action need be taken and the process ends. If the dirty flag 210 has not been cleared, the dirty flag 210 is cleared in step 520 to indicate that all data in the flush-cache location have been written to their correct locations on disk and the process ends.

If it is determined in step 505 that the free pointer 110 has not passed the fill pointer location stored in memory, steps 540, 550, and 560 are carried out. In step 540, the disk drive writes the data entry of write-cache 100 pointed to by free pointer 110 to its correct location on disk. The dirty flag of the data entry is cleared in step 550 and the free pointer 110 is incremented in step 560. Steps 540, 550, and 560 are repeated until the free pointer 110 passes the fill pointer location stored in memory. In an alternative embodiment, the disk drive may write the dirty data entries of write cache 100 to their correct locations on disk out of sequential order (i.e., not incrementing free pointer 110, as in step 560) to increase efficiencies, for example, by leveraging the mechanical state of the drive (e.g., writing data for disk locations that are currently closest to the disk head, etc.).

The foregoing techniques provide assurances that data stored in flush-cache location 200 will be timely committed to their correct locations on disk within a predetermined amount of time (e.g., as indicated by the timer of step 445). This time period can be set in a number of different ways including: by the disk drive manufacturer, by the host computer or software running on the host computer, etc. In situations where a flush-cache command is not followed by a subsequent flush-cache command for a long period of time, the foregoing techniques prevent stale data stored in flush-cache location 200 from overwriting more current data stored on disk in the case when the disk drive loses power unexpectedly.

In the embodiments of the invention described above, the flush-cache timer is set after the flush-cache command has completed execution. In alternative embodiments, the flush-cache timer may be set at the beginning of flush-cache command execution or even during the flush-cache command execution.

It should also be recognized that alternative embodiments other than those depicted in the foregoing may be implemented without departing from the spirit of the invention. For example, rather than comparing the current free pointer 110 to a stored fill pointer 215 in step 520 to determine when all data in flush-cache location 200 has been written to their correct locations on disk, an alternative embodiment may track fill pointer 105 to determine when it cycles back to the same location in the circular buffer structure when dirty flag 210 in flush-cache location 200 had been set. Other alternatives may implement write-cache using data structures other than a circular buffer and the disk drive may have additional and/or alternative memory components, data structures and control logic to keep track of which data entries in write-cache 100 correspond to the data stored in flush-cache location 200. For example, in an alternative embodiment, each entry in write-cache 100 may also include an additional field indicating whether the entry is also currently stored in flush-cache location 200. Upon a scan of write-cache 100, the disk drive can then determine whether all data in flush-cache location 200 has been committed to their correct location in memory (e.g., by confirming that each entry whose flush-cache location field is set also has its dirty flag cleared). Similarly, the foregoing techniques may be utilized with multiple flush-cache locations such as described in Ehrlich-Zayas Publication.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

1. A method for managing a write-cache of a disk drive, the method comprising the steps of:
writing at least a portion of data stored in said write-cache onto a flush cache location on disk upon receiving a flush cache command;
setting a dirty flag corresponding to said flush cache location;
writing at least a portion of data stored in said write-cache onto locations on disk when a predetermined amount of time has elapsed since execution of the flush cache command; and
clearing the dirty flag corresponding to said flush cache location.

2. The method of claim 1, wherein the data stored in said write-cache that are written to said flush cache location are indicated as being dirty.

3. The method of claim 2, wherein the dirty flag is cleared when the data stored in said write-cache that are written to said flush cache location are no longer indicated as being dirty.

4. The method of claim 1, wherein said write-cache has a circular buffer data structure including a fill pointer pointing to a next free entry in said write-cache and a free pointer pointing to a end of free entries in said write-cache, and a value of the free pointer is updated as data is written onto said locations on disk.

5. The method of claim 4, further comprising the step of storing a value of said fill pointer after said flush cache command has executed, wherein the dirty flag corresponding to said flush cache location is cleared when the value of the free pointer passes the stored value of the fill pointer.

6. The method of claim 1, further comprising the steps of:
setting a timer after the flush cache command has executed; and
determining that the predetermined amount of time has elapsed using the timer.

7. The method of claim 6, further comprising the step of resetting the timer each time a new flush cache command is executed.

8. A disk drive comprising:
a disk;
a volatile memory write-cache;
a non-volatile memory flush-cache location; and
a controller that is configured to: (a) write data stored in the write-cache into the flush-cache location upon receiving a flush cache command and set a dirty flag corresponding to the flush-cache, and (b) write data stored in the write-cache onto locations on the disk when a predetermined amount of time has elapsed since execution of the flush cache command and clear the dirty flag.

9. The disk drive of claim 8, wherein the write-cache is a DRAM.

10. The disk drive of claim 8, wherein the flush-cache is provided on said disk.

11. The disk drive of claim 8, wherein the flush-cache comprises an EEPROM.

12. The disk drive of claim 8, wherein the write-cache comprises a plurality of entries, wherein each entry in said write-cache comprises a dirty flag field, data field and data location field.

13. The disk drive of claim 8, wherein the write-cache has a circular buffer data structure including a fill pointer pointing to a next free entry in said write-cache and a free pointer pointing to a end of free entries in said write-cache, and a value of the free pointer is updated as data is written onto said locations on disk.

14. The disk drive of claim 13, wherein the flush cache location stores write data stored in the write-cache when a flush cache command is received, dirty flag corresponding to the write data, and a value of the fill pointer when the flush cache command is executed.

15. A computer readable storage medium having stored therein computer readable instructions, wherein a controller of a disk drive executing the instructions carries out the steps of:
writing at least a portion of data stored in a write-cache of the disk drive onto a flush cache location on a disk of the disk drive upon receipt of a flush cache command;
setting a dirty flag corresponding to said flush cache location;
writing at least a portion of data stored in said write-cache onto locations on said disk when a predetermined amount of time has elapsed since execution of the flush cache command; and
clearing the dirty flag corresponding to said flush cache location.

16. The computer readable storage medium of claim 15, wherein the controller executing the instructions carries out the further steps of:
setting a timer when the flush cache command is executed; and
determining that the predetermined amount of time has elapsed using the timer.

17. The computer readable storage medium of claim 16, wherein the controller executing the instructions carries out the further step of resetting the timer each time a new flush cache command is executed.

18. The computer readable storage medium of claim 15, wherein the write-cache has a circular buffer data structure including a fill pointer pointing to a next free entry in said write-cache and a free pointer pointing to a end of free entries in said write-cache and the controller executing the instructions carries out the further step of updating a value of the free pointer as data is written onto the locations on said disk.

19. The computer readable storage medium of claim 18, wherein the controller executing the instructions carries out the further step of storing a value of said fill pointer when said flush cache command is executed.

20. The computer readable storage medium of claim 19, wherein the controller executing the instructions clears the dirty flag corresponding to said flush cache location when the value of the free pointer passes the stored value of the fill pointer.
